(19) United States
(12) Patent Application Publication
(10) Pub. No.: US 2004/0017991 A1
(43) Pub. Date: Jan. 29, 2004

(54) Refractive index control

(75) Inventor: Dominic Joseph Brady, Abingdon (GB)

Correspondence Address: SUGHRUE MION, PLLC, 2100 Pennsylvania Avenue, NW, Washington, DC, 20037-3213, US

(73) Assignee: BOOKHAM TECHNOLOGY LIMITED

(21) Appl. No.: 10/368,390

(22) Filed: Feb. 20, 2003

(30) Foreign Application Priority Data
Feb. 22, 2002 (GB) 0204215.8

(51) Int. Cl. G02B 6/10

(52) U.S. Cl. 385/130; 385/37

(57) ABSTRACT

A method of selectively adjusting the refractive index of the propagating portion of an optic waveguide, the method including the step of implanting into selected portions of the propagating portion of the optic waveguide a dopant material selected so as to minimise the number of additional attenuating, extrinsic charge carriers in the propagating portion of the optic waveguide.

### FIELD OF THE INVENTION

The present invention relates to a method of selectively adjusting the refractive index of an optic waveguide.

### BACKGROUND OF THE INVENTION

An optic waveguide propagates an optic signal according to the physical dimensions of the waveguide and the refractive index of the material constituting the waveguide. It is an aim of the present invention to provide a method for adjusting the refractive index of an optic waveguide for controlling the propagation characteristics of the waveguide.

In some optic devices, it is important to control the optical path length (OPL) of a waveguide in a relatively precisely defined manner. In some instances, it can be difficult to control such parameters in the desired manner by geometrical factors alone. Adjusting the refractive index of a waveguide after its physical dimensions are finalised is one way of controlling its optical path length.

A conventional method of changing the optical path length of an optic waveguide involves irradiation with ultraviolet light, so as to alter the refractive index and hence the propagation characteristics of the waveguide whilst maintaining the low loss characteristics of the waveguide.

### SUMMARY OF THE INVENTION

According to a first aspect of the present invention, there is provided a method of selectively adjusting the refractive index of the propagating portion of an optic waveguide, the method including the step of implanting into selected portions of the propagating portion of the optic waveguide a dopant material selected so as to minimise the number of additional attenuating, extrinsic charge carriers in the propagating portion of the optic waveguide.

According to another aspect of the present invention, there is provided a method of adjusting the optical path length difference between waveguides in an interferometric optic device, the method including the step of implanting into at least one of the waveguides a dopant material selected to change the refractive index of the propagating portion of the waveguide whilst minimising the number of additional attenuating, extrinsic charge carriers in the waveguide.

According to another aspect of the present invention, there is provided a wavelength dispersive device including an array waveguide grating, wherein the array waveguide grating has a propagating portion implanted with a material selected to change the refractive index of the propagating portion whilst minimising the number of additional attenuating, extrinsic charge carriers in the propagating portion, wherein the implanted portion serves to establish a common optical path length difference between each pair of adjacent waveguides of the array waveguide grating.

According to another aspect of the present invention, there is provided a method of controlling the refractive index profile of a slab waveguide constituting a fee propagation region at the output end of a wavelength dispersive device, the method including the step of implanting into selected portions of the propagating portion of the slab waveguide a dopant material selected to change the refractive index of the propagating portion of the slab waveguide whilst minimising the number of additional attenuating, extrinsic charge carriers in the waveguide.

According to another aspect of the present invention, there is provided an optic wavelength dispersive device including an array waveguide grating and an array of output waveguides arranged with respect to each other about a slab waveguide having a propagating portion constituting a free propagation region in a Rowland circle arrangement, wherein selected portions of the propagating portion of the slab waveguide are doped with a material selected to change the refractive index of the propagating portion of the slab waveguide whilst minimising the number of additional attenuating, extrinsic charge carriers in the propagating portion of the slab waveguide, so as to minimize the variation in optical path length difference between each waveguide of the arrayed waveguide grating and each output waveguide.

According to another aspect of the present invention, there is provided a method of controlling the degree of evanescent coupling between two longitudinal silicon rib waveguides defined in parallel in a silicon optic chip, the method including the step of implanting into a portion of the optic chip located laterally between the two ribs a dopant material selected to change the refractive index of the waveguide whilst minimising the number of additional attenuating, extrinsic charge carriers in the propagating portion of the optic waveguide.

According to another aspect of the present invention, there is provided a method of tapering the optical confinement of a silicon waveguide at an end adjacent to a free propagating region, the method including the step of implanting into selected portions of the waveguide a dopant material selected to change the refractive index of the waveguide whilst minimising the number of additional attenuating, extrinsic charge carriers in the propagating portion of the optic waveguide.

According to another aspect of the present invention, there is provided an optic device including at least one silicon waveguide having one end connected to a free propagating region, wherein the waveguide has a selected portion doped with a material selected to change the refractive index of the waveguide whilst minimising the number of additional attenuating, extrinsic charge carriers in the waveguide, so as to gradually degrade the optical confinement of the waveguide at said end in a controlled manner towards the free propagation region.

According to another aspect of the present invention, there is provided a method of controlling the polarisation mode dispersion of an optic signal propagated along a waveguide, the method including the step of implanting into the waveguide a dopant material selected to change the refractive index of the waveguide whilst minimising the number of additional attenuating extrinsic charge carriers in the waveguide, the implanting carried out at selected areas of the waveguide that preferentially interact with one polarisation mode.

According to another aspect of the present invention, there is provided an optic device including an optic waveguide, wherein selected portions of the waveguide are implanted with a dopant material selected to change the refractive index of the waveguide whilst minimising the number of additional attenuating extrinsic charge carriers in the waveguide, the implantation serving to eliminate polarisation mode dispersion.

According to another aspect of the present invention, there is provided a method of selectively adjusting the refractive index of a silicon optic waveguide, the method including the step of implanting into selected portions of the waveguide a dopant material selected so as to minimise the number of additional attenuating extrinsic charge carriers in the optic waveguide.

### BRIEF DESCRIPTION OF THE DRAWINGS

Embodiments of the present invention are described hereunder, by way of non-limiting example only, with reference to the accompanying drawings, in which:

FIG. 1 is a plan view of an AWG-based optic device;

FIG. 2 is a cross-sectional view of a silicon rib waveguide;

FIG. 3(a) is an explanatory plan view of the output fee propagation region of a device as shown in FIG. 1, and FIG. 3(b) illustrates such a region as produced using a method according to the present invention;

FIG. 4 is a cross-sectional view and plan view of an end portion of the AWG of a device as shown in FIG. 1 produced using a method according to the present invention;

FIG. 5 is a schematic view of a Mach-Zehnder type interferometer produced using a method according to the present invention; and

FIG. 6 is a schematic view of an interleaver type structure produced using a method according to the present invention;

FIG. 7 is a cross-sectional view of a silicon rib waveguide produced using a method according to the present invention; and

FIG. 8 illustrates the use of doping to control the degree of evanescent coupling between two silicon rib waveguides according to an aspect of the present invention.

### DESCRIPTION OF PREFERRED EMBODIMENT

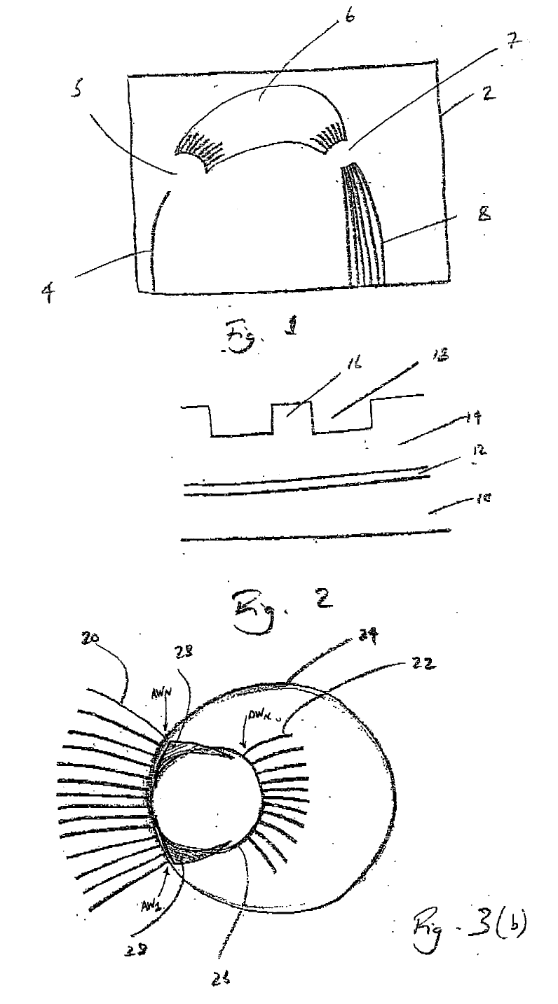

A first method of the present invention has particular application in improving the performance of optic devices based on an array waveguide grating (AWG). An example of such a device is shown in FIG. 1, and includes an array waveguide grating 6 having an input end for receiving an optical signal from an input waveguide 4 via a first free propagation region 5 and an output end for directing the optic signal to an array of output waveguides 8 via a second free propagation region 7. This type of device may be used as a demultiplexer for separating a wavelength-division multiplexed (WDM) signal into its components channels for flier independent transmission or processing (or in reverse as a multiplexer), or as a channel optical monitor for measuring the optical power of each channel of a WDM signal.

The device may, for example, be a silicon optic device in which the input waveguide. 4, the output waveguides 8 and the waveguides of the AWG 6 are rib waveguides having the structure shown in FIG. 2, and the free propagation regions are slab waveguides. With reference to FIG. 2, each rib waveguide 16 is formed by etching trenches 18 in an epitaxial silicon layer 14 formed on a silicon substrate 10 via a silicon oxide layer 12 as an optical confinement layer.

In a first embodiment of the present invention, doping of the silicon waveguides of the AWG is used to compensate for deficiencies in the dimensions of the waveguides of the AWG, which may result from systematic design errors or from errors resulting from unavoidable variations in the conditions of the production process. Deviations from the ideal OPL relationship between the waveguides of the AWG can result in phase errors and consequently increased insertion losses and cross-talk between channels in the output waveguides. These deficiencies are resolved by implanting selected portions of the AWG waveguides with a dopant such as germanium or other electrically inactive element. Germanium increases the refractive index of the portion of the silicon waveguide into which it is implanted, but dopants that reduce the refractive index may also be used. Implantation into selected portions of the propagating portion of the waveguide can be carried out using industry standard techniques, such as focussed ion beam implantation, employed in the doping of silicon with Gp. III or Gp. V dopants for other purposes such as producing pin diode optical attenuators. This also applies to the other embodiments described below.

This will generally involve implanting some waveguides of the array with more dopant than others. This can be achieved by exposing a common area size of each waveguide to varying concentrations of the dopant or by maintaining the dopant concentration at a uniform level and varying the exposure area for each waveguide, by for example using a mask of an appropriate pattern. The implantation could be performed on a per-device basis with the dose and direction determined by an interferometric measurement of the phase errors for each individual device, or could be performed with reference to known systematic design errors which result in phase errors consistent from chip to chip.

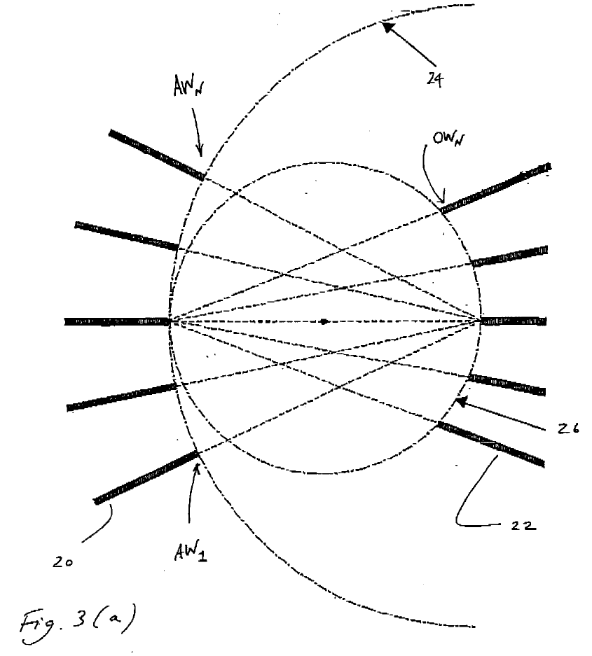

In a second embodiment of the present invention, doping is used to partially correct inherent inadequacies in the physical arrangement of the output waveguides with respect to the output end of the AWG about the output free propagation region, in which the light is unconstrained and free to propagate in the two dimensions of the epitaxial silicon layer. Ideally, when the ideal OPL relationship is met for the AWG waveguides, the optical path length across the free propagation region from every array waveguide to every output waveguide is constant. Conventionally, the ends of the output waveguides and the AWG waveguides are arranged about the free propagation region of uniform refractive index in a Rowland circle arrangement as shown in FIG. 3(a) with the ends of the output waveguides 22 arranged on the circumference of a small circle 26, and the ends of the AWG waveguides 22 arranged on the circumference of a large circle 24 whose centre lies on the circumference of the small circle. Although considered to be a reasonable compromise, the Rowland circle arrangement does not provide the ideal relationship discussed above. For example, the distance between the end of output waveguide OW_{N} and the end of array waveguide AW_{N} is clearly significantly shorter than the distance between it and the end of array waveguide AW_{I}. Such deviation from the ideal relationship can result in increased insertion losses and channel crosstalk in the output waveguides or additional channel ripple.

As illustrated in FIG. 3(b), implanting selected portions 28 of the slab waveguide constituting the free propagation region with a dopant such as germanium is used to partially correct for these inherent inadequacies in the Rowland circle arrangement. Germanium increases the refractive index (and hence optical path length) of the portion of the silicon slab waveguide into which it is implanted, but dopants that reduce the refractive index may also be used. Clearly the dopant patterning for such refractive index-reducing dopants would be different to that for refractive index-increasing dopants.

The above-described applications of the technique of the present invention are considered particularly useful for AWE-based demnultiplexers, in which each output waveguide is associated with a respective channel and in which it is important to avoid channel cross-talk as much as possible.

In a third embodiment of the present invention, doping is used to control the coupling between the waveguides of an AWG at their end portions adjacent the fire propagation region. With reference to IEEE Photonics Technology Letters, Vol. 12, No. 9, pp. 1180-1182, it has been observed that by gradually degrading the waveguide confinement of the array waveguides at these end portions increased coupling occurs between the waveguides which causes a slow spreading of the light and smoothes the transition from the array to the free propagation region, resulting in a substantial decrease in the loss of the array. Conventionally, this degrading of the waveguide confinement has been carried oat by outwardly geometrically tapering the end portions of the array waveguides, either in the vertical direction, horizontal direction or both directions. In the case of silicon waveguides, geometrical horizontal tapering is carried out during the process of etching to define the rib waveguides, but process variability means that the step width (lateral width between ribs at the very end of the array) is not well controlled if small widths are set with the aim of reducing the loss. Vertical outward tapering of silicon ribs requires the use of greyscale photolithography masks during the process of etching to define the ribs and considerably more complex processing capabilities.

According to the present invention, doping of the end portions of the array waveguide adjacent the free propagation region is used to control the waveguide confinement in the desired manner. In the case of a silicon device, the portions 31 of the epitaxial silicon layer between the ribs 30 is implanted with a dopant such as germanium in a manner as shown schematically in FIG. 4. Implantation of germanium (which has a high refractive index compared to silicon) has the result of degrading the confinement. The use of implantation allows the waveguide confinement to be precisely degraded in a relatively easily and reproducibly controlled way. The spread of the optic mode in each waveguide can be accurately controlled by altering the patterning of the doping arid/or the dose of implantation.

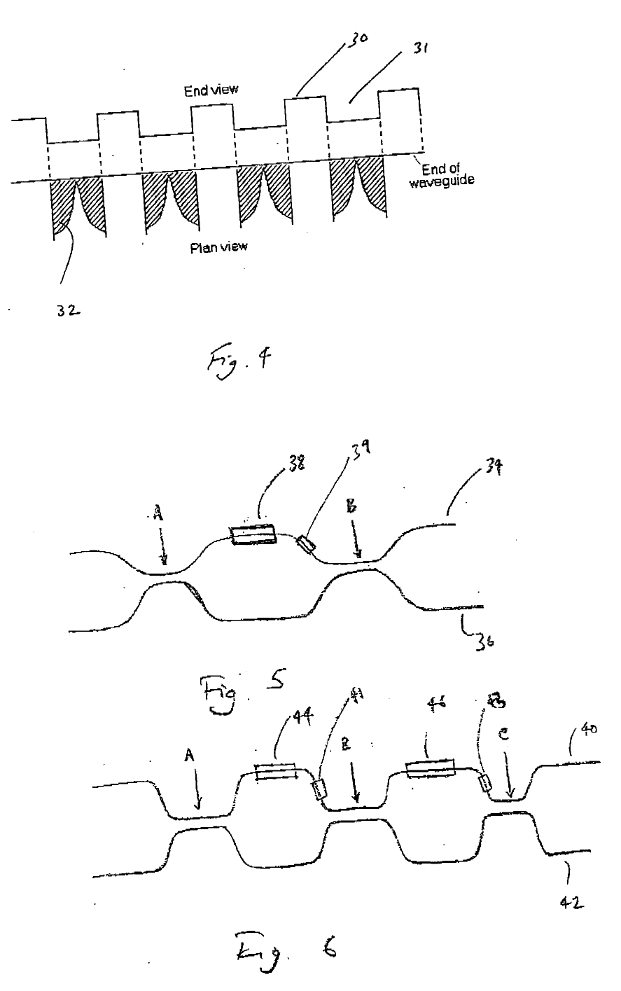

In another embodiment of the present invention, doping is used to modify the optical path lengths of one or more arms of an interferometric device. One example of such a device, a silicon-based Mach-Zehnder switch, is shown in FIG. 5. It includes two silicon rib waveguides 34, 36 that are arranged for evanescent coupling between them at two locations A and B. An electrically controllable device 38 is associated with one of the waveguides at a location between A and B for reversibly adjusting the optical path length of that waveguide by an electrooptic or thermooptic effect.

For the wavelength of interest, the lengths of each of the two waveguides between locations A and B are selected such that an “on” state of maximum constructive interference and an “off” state of maximum destructive interference can be achieved with different power inputs to device 38.

The lengths of the waveguides between locations A and B are normally designed such that a maximum contrast ratio is achieved for a pair of given power inputs. Small deviations away from the ideal in regard to the relative lengths of the two waveguides between A and B can easily result front variations in the production process, and such small deviations can cause an undesirable decrease in the contrast ratio for the pair of given power inputs. In an embodiment of the present invention, such small deviations are compensated for by implanting a dopant such as germanium in a portion 39 of one of the waveguides between locations A and B. The degree of compensation is controlled by adjusting the length of the implanted portion and/or the implantation concentration.

In some instances, the switch will have been designed to be in an “off” state for a given level of power input. After production, it may be desired that the switch is in the “off” state for a different level of power input According to another embodiment of the present invention, implantation of a dopant such as germanium into a portion of the one of the waveguides between A and B is used to adjust the total optical path length of that waveguide between A and B to the extent that the switch is in the “off” state for the desired new level of power input.

In another embodiment of the present invention, doping is used to tune an interleaver type structure of the kind shown in FIG. 6. The interleaver type structure includes two waveguides 40, 42 configured for evanescent coupling between them at points A, B and C. The portions of the waveguides between A and B and B and C define two MZ interferometers, whose transmission state can be adjusted by controlling the power input to the respective one of the thermooptic or electrooptic devices 44, 46. In this embodiment of the invention, fine tuning of each MZ interferometer is carried out by implanting a controlled amount of dopant into a portion 41, 43 of one of the waveguides between A and B and/or between B and C. The degree of tuning required may be different for each M-Z interferometer, and accordingly the determination of the required optical path length change required and the implantation process are carried out independently for each interferometer. An interleaver relies on certain evanescent coupling ratios. According to another aspect of the present invention, the coupling ratios are tuned by doping the optic material between the waveguides at one or more of the points A, B and C, as illustrated in FIG. 8 for the case of silicon rib waveguides, in a technique similar to that described earlier for controlling the coupling between the ends of the waveguides of an array waveguide grating. In FIG. 8, a portion of the epitaxial silicon 48 lying laterally between the waveguide ribs is doped with an electrically inactive element to control the coupling ratio between the waveguides.

In another embodiment of the present invention, doping is used to control polarisation mode dispersion in an optic waveguide. Doping may be used to deliberately induce a polarisation mode dispersion or to control an undesired polarisation mode dispersion. Controlling unwanted polarisation mode dispersion in the waveguides of an interferometric device, such as an AWG-based wavelength-dispersive device or MZ switch can reduce or eliminate undesirable polarisation dependent frequency (PDF) effects.

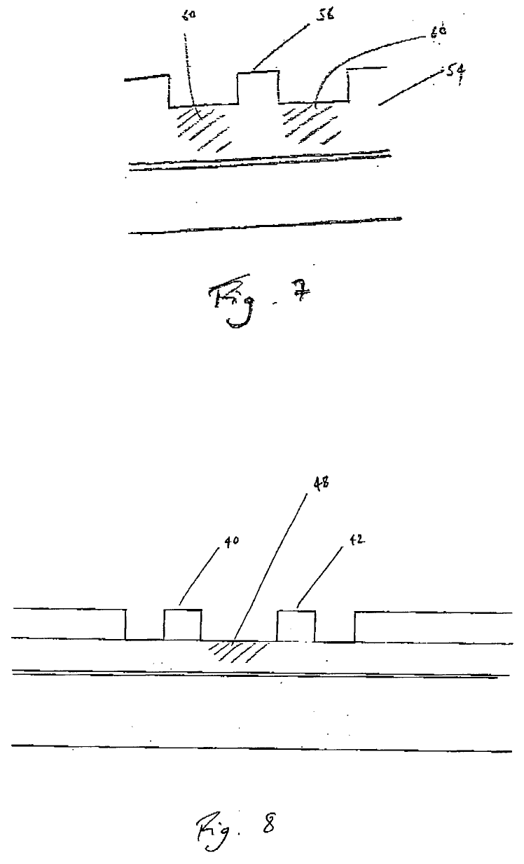

Some portions of an optic waveguide tend to interact more with one polarisation mode than another. For example, in a silicon rib waveguide as shown in FIG. 7, the portions 60 of the epitaxial silicon layer 54 laterally adjacent the rib tend to act with one polarisation mode greater than another. In this embodiment of the present invention, these regions are doped with either a refractive index reducing dopant or refractive index increasing dopant depending on whether it is desired to selectively decrease or increase the optical path length for that mode with which these portions preferentially interact

The applicant draws attention to the fact that the present invention may include any feature or combination of features disclosed herein either implicitly or explicitly or any generalisation thereof, without limitation to the scope of any definitions set out above. In view of the foregoing description it will be evident to a person skilled in the art that various modifications may be made within the scope of the invention.

What is claimed is:

1. A method of selectively adjusting the refractive index of the propagating portion of an optic waveguide, the method including the step of implanting into selected portions of the propagating portion of the optic waveguide a dopant material selected so as to minimise the number of additional attenuating, extrinsic charge carriers in the propagating portion of the optic waveguide.

2. A method according to claim 1, wherein the method is used to adjust the optical path length difference between waveguides in an interferometric optic device.

3. A method according to claim 2 wherein the interferometric device is selected from the group consisting of an array waveguide grating and a Mach-Zehnder switch.

4. A wavelength dispersive device including an array waveguide grating, wherein the array waveguide grating has a propagating portion implanted with a material selected to change the refractive index of the propagating portion whilst minimising the number of additional attenuating, extrinsic charge carriers in the propagating portion, wherein the implanted portion serves to establish a common optical path length difference between each pair of adjacent waveguides of the array waveguide grating.

5. A method of controlling the refractive index profile of a slab waveguide constituting a free propagation region at the output end of a wavelength dispersive device, the method including the step of implanting into selected portions of the propagating portion of the slab waveguide a dopant material selected to change the refractive index of the propagating portion of the slab waveguide whilst minimising the number of additional attenuating, extrinsic charge carriers in the waveguide.

6. An optic wavelength dispersive device including an array waveguide grating and an array of output waveguides arranged with respect to each other about a slab waveguide having a propagating portion constituting a free propagation region in a Rowland circle arrangement, wherein selected portions of the propagating portion of the slab waveguide are doped with a material selected to change the refractive index of the propagating portion of the slab waveguide whilst minimising the number of additional attenuating, extrinsic charge carriers in the propagating portion of the slab waveguide, so as to minimize the variation in optical path length difference between each waveguide of the arrayed waveguide grating and each output waveguide.

7. A method of controlling the degree of evanescent coupling between two longitudinal silicon rib waveguides defined in parallel in a silicon optic chip, the method including the step of implanting into a portion of the optic chip located laterally between the two ribs a dopant material selected to change the refractive index of the waveguide whilst minimising the number of additional attenuating, extrinsic charge carriers in the propagating portion of the optic waveguide.

8. A method according to claim 7, wherein the silicon rib waveguides form part of an interleaver device.

9. A method of tapering the optical confinement of a silicon waveguide at an end adjacent to a free propagating region, the method including the step of implanting into selected portions of the waveguide a dopant material selected to change the refractive index of the waveguide whilst minimising the number of additional attenuating, extrinsic charge carriers in tile propagating portion of the optic waveguide.

10. An optic device including at least one silicon waveguide having one end connected to a free propagating region, wherein the waveguide has a selected portion doped with a material selected to change the refractive index of the waveguide whilst minimising the number of additional attenuating, extrinsic charge carriers in the waveguide, so as to gradually degrade the optical confinement of the waveguide at said end in a controlled manner towards the free propagation region.

11. A method of controlling the polarisation mode dispersion of an optic signal propagated along a waveguide, tie method including the step of implanting into the waveguide a dopant material selected to change the refractive index of the waveguide whilst minimising the number of additional attenuating extrinsic charge carriers in the waveguide, the implanting carried out at selected areas of the waveguide that preferentially interact with one polarisation mode.

12. An optic device including an optic waveguide, wherein selected portions of the waveguide are implanted with a dopant material selected to change the refractive index of the waveguide whilst minimising tie number of additional attenuating extrinsic charge carriers in the waveguide, the implantation serving to eliminate polarisation mode dispersion.

13. A method according to claim 1, wherein the one or more waveguides are silicon waveguides, and the dopant is selected from the group consisting of germanium, tin and lead.

14. A method according to claim 2, wherein the one or more waveguides are silicon waveguides, and the dopant is selected from the group consisting of germanium, tin and lead.

15. A device according to claim 4, wherein the one or more waveguides arc silicon waveguides, and the dopant is selected from the group consisting of germanium, tin and lead.

16. A method according to claim 5, wherein the one or more waveguides are silicon waveguides, and the dopant is selected from the group consisting of germanium, tin and lead.

17. A device according to claim 6, wherein the one or more waveguides are silicon waveguides, and the dopant is selected from the group consisting of germanium, tin and lead.

18. A method according to claim 11, wherein the one or more waveguides are silicon waveguides, and the dopant is selected from the group consisting of germanium, tin and lead.

19. A device according to claim 12, wherein the one or more waveguides are silicon waveguides, and the dopant is selected from the group consisting of germanium, tin and lead.

20. A method of selectively adjusting the refractive index of a silicon optic waveguide, the method including the step of implanting into selected portions of the waveguide a dopant material selected 50 as to minimise the number of additional attenuating extrinsic charge carriers in the optic waveguide.
